(19) United States
(12) Patent Application Publication
(10) Pub. No.: US 2003/0052920 A1
(43) Pub. Date: Mar. 20, 2003

(54) Document navigation system

(76) Inventor: Stan Carter, Chattanooga, TN (US)

Correspondence Address: GREENBERG TRAURIG, P.A., 1221 Brickell Avenue, Miami, FL, 33131, US

(21) Appl. No.: 10/246,051

(22) Filed: Sep. 18, 2002

Related U.S. Application Data
(60) Provisional application No. 60/323,555, filed on Sep. 20, 2001.

(51) Int. Cl. G09G 5/00

(52) U.S. Cl. 345/764; 345/781

(57) ABSTRACT

A document navigation system that facilitates efficient identification and display of a document by using navigation parameters is described. Using navigation parameters, users can easily scroll through documents from a single document window. Moreover, size information provides additional information regarding the association of stored documents with the currently displayed document. The method includes providing a document window for displaying all or a portion of one or more of the documents. The method provides a control item comprising a plurality of selectable time-based navigation parameters. Input commands setting the navigation parameters to define time-based document selection criteria are received. A closest-fit document having identification parameters that most closely correspond to the document selection criteria is identified. The method displays all or a portion of the closest-fit document in the document window.

### PRIOR U.S. APPLICATION

This Specification is based on U.S. Provisional Application Serial No. 60/323,555 filed on Sep. 20, 2001. The inventors claim the benefit of Title 35, Section 119 of the U.S. Code based on said provisional application.

### COPYRIGHT NOTICE

A portion of the disclosure of this patent document contains material which is subject to copyright protection. The copyright owner has no objection to the facsimile reproduction by anyone of the patent document or the patent disclosure as it appears in the Patent and Trademark Office Patent file or records, but otherwise reserves all copyright rights whatsoever.

### TECHNICAL FIELD

The present invention relates generally to the field of document management and searching systems. In particular, it relates to a document navigation system that facilitates efficient identification and display of a document by using time-based navigation parameters.

### BACKGROUND OF THE INVENTION

As processing capability increases and the cost of personal computers decreases, personal computer use continues to grow. Schools, homes, and business use computers for task previously done without them. As a result, creating effective document displays has become a greater concern. Software applications, such as Corel® WordPerfect® and Microsoft® Outlook®, typically display documents using “window-type” workspaces. Software applications often include features, such as tiling, that can arrange these workspaces within a single screen. Each of the workspaces can display a single document. Simultaneous use of several workspaces enables display of many documents.

By displaying several windows within a single screen, a user can alternate between documents. Though functional, this display method creates several disadvantages by placing documents in unrelated workspaces. Often, a user opens a document by searching a document storage system. After identifying the document, the computer system displays this document in a document window. For a search of documents related to Jane Smith, the computer system could display Jane's biographical summary. Incorporating information from Jane's resume into this biographical sketch could warrant opening Jane's resume.

The present display method does not efficiently identify and display the document most closely related to the currently displayed document. For example, the next relevant document resulting from the search of documents related to Jane could be Jane's resume. To display Jane's resume, a user typically must repeat the steps of the document opening process. Repeating previously executed steps can be time consuming and inefficient. In addition, switching between open document windows often necessitates navigating toolbars and pull down menus. This navigation consumes more time. Hence, an easier way to switch between documents within a single document window would create substantial benefits.

Despite the development of document display systems, conventional solutions fail in providing a document management system that is not laden with considerable time losses due to inefficient searching and navigation between multiple document windows. Thus, a need still exists for an improved document navigation system.

### SUMMARY OF THE INVENTION

The present invention meets the needs described above in a document navigation system that facilitates efficient identification and display of a document using navigation parameters. The invented system includes a navigation bar for identifying and displaying documents. The partially collapsible nature of this bar enables its use without creating a substantial obstruction within an associated computer screen. Implementation of the navigation bar using software enables its use with various types of digital devices, such as a personal digital assistant, pocket pc, game system, or a computer. Thus, electronic devices with limited storage capacities and devices with complicated electronics can utilize the document navigation system of the present invention.

In addition to enabling use with various electronic devices, the present invention allows efficient navigation to a wide range of documents within a single document window. Instead of using a series of pull down menus to open a document, the present invention allows effective navigation using a sophisticated navigation bar. This navigation bar includes a host of radio buttons associated with navigation parameters such as day of the week, date, month, week, and year. When a user expands the navigation bar, each navigation parameter includes a pair of directional buttons. By selecting of the directional buttons, users can display documents stored on the digital device by scrolling from the currently displayed document to a stored document. For example, a user may scroll from a document created on Thursday at 10:00 a.m. to a document created on Thursday at 10:30 a.m. by selecting one of the directional buttons. Hence, users can quickly and easily navigate to a wide range of documents using a single document window.

In addition to directional buttons, the navigation bar includes size indication that identify the number of documents associated with a particular search. A group size indicator identifies the number of documents that satisfy a user's search request. For example, a search for email messages referring to bananas may return twenty-five documents. Thus, a group size of twenty-five indicates the number of documents that satisfied the request for email messages referring to bananas. A number available (NAV) identifies the number of documents accessible from a particular navigation parameter. For example, a NAV size of ten indicates that only ten of the twenty-five documents were sent during 2001. A subgroup size of 5 indicates the number of documents available earlier or later in the current month. By reviewing the size indicators, a user can easily understand the size of the search results and the association of these results to the currently displayed documents.

Generally described, the invention is a method for identifying and displaying documents within a computer-based document management system, each document having a defined set of identification parameters. The method includes providing a document window for displaying all or a portion of one or more of the documents. The method provides a control item that includes a plurality of selectable time-based navigation parameters. Input commands setting the navigation parameters to define time-based document selection criteria are received. A closest-fit document having identification parameters that most closely correspond to the document selection criteria is identified. The method displays all or a portion of the closest-fit document in the document window.

In view of the foregoing, it will be appreciated that the document navigation system avoids the drawbacks of prior systems. The specific techniques and structures employed by the invention to improve over the drawbacks of the prior systems and accomplish the advantages described above will become apparent from the following detailed description of the embodiments of the invention and the appended drawings and claims.

### BRIEF DESCRIPTION OF THE DRAWINGS

FIG. 1 is a functional block diagram of a document navigation system used with a computer.

FIG. 2A is a functional block diagram of the navigation bar of FIG. 1 illustrating navigational parameters that allow user selection of a particular document.

FIG. 2B is a functional block diagram of an expanded navigation bar that results from selecting the earlier/later button of FIG. 2A.

FIG. 2C is a functional block diagram of an expanded navigation bar illustrating the identification parameters displayed after selecting the navigation indicator of FIG. 2B.

FIG. 3A is a functional block diagram of the expanded navigation bar illustrating sub-navigation indicators.

FIG. 3B is a function block diagram of an expanded navigation bar illustrating selection of the sub-navigation indicator of FIG. 3A.

FIG. 3C is a functional block diagram of an expanded navigation bar illustrating the properties of a subsequent email message.

FIG. 4A is a functional block diagram of an expanded navigation bar illustrating the results of a document type and document subject search.

FIG. 4B is a functional block diagram of an expanded navigation bar illustrating the result of selecting the navigation indicator.

FIG. 5A is a table illustrating the relationship of various navigation parameters as a navigation indicator varies one navigation parameter.

FIG. 5B is a table illustrating the relationship of various navigation parameters as scrolling to the next available document varies a navigation indicator.

FIG. 5C is a table illustrating the relationship of various navigation parameters as a sub-navigation indicator varies a navigation indicator.

FIG. 6 is a flow diagram of a routine that controls the document navigation system.

FIG. 7 is a flow diagram illustrating a subroutine of the routine of FIG. 6 that determines the selected document group.

FIG. 8 is a flow diagram illustrating a subroutine of the routine of FIG. 6 that receives a navigation command and changes the navigation display.

FIG. 9 is a flow diagram illustrating a subroutine for the routine of FIG. 8 that modifies the navigation display for a time navigation parameter.

FIG. 10 is a flow diagram illustrating a subroutine for the routine of FIG. 8 that modifies the navigation display for the day of the week navigation parameter.

FIG. 11 is a flow diagram illustrating a subroutine for the routine of FIG. 9 that modifies the navigation display for the date navigation parameter.

FIG. 12 is a flow diagram illustrating a subroutine for the routine of FIG. 9 that modifies the navigation display for the month navigation parameter.

FIG. 13 is a flow diagram illustrating a subroutine for the routine of FIG. 9 that modifies the navigation display for the week navigation parameter.

FIG. 14 is a flow diagram illustrating a subroutine for the routine of FIG. 9 that modifies the navigation display for the year navigation parameter.

### DETAILED DESCRIPTION OF THE EMBODIMENTS

The present invention may be embodied in a document navigation system that interfaces between a display and a digital device. The digital devices could include a personal computer, personal digital assistant, digital pager, digital cellular phone, or some other suitable device. Often these digital devices either include some type of display such as a liquid crystal display, monitor, digital camcorder, or some other suitable device. Alternatively, the display could be separate from the digital device such as a television, video projector, or some other suitable device.

When the display includes a screen, a document window displays documents stored on the digital device. The documents could be electronic mail (email) messages, digitized voice messages, word processing documents, spreadsheet documents, or some other type of document. Typically, the digital device includes some type of document storage device such as a document database, floppy disk, compact disc, or some other suitable storage device. This document storage device maintains the integrity of the stored documents. Moreover, each stored document can include identification parameters that enable identification and subsequent retrieval of the document.

Within the document window, a navigation bar including a number of control items, manages the retrieval from the document storage location and display of documents within the document window. The navigation bar includes various buttons for document searching using a host of time-based parameters such as earlier/later, time, day of the week, date, month, week, or year. In addition, the navigation bar can include parameters such as author, creation date, previous recipients, document size, or some other suitable parameter. For each of these buttons, the navigation bar can include an earlier and a later button that scrolls the particular navigation parameter. For example, selecting earlier button can scroll the year parameter to the previous year.

The navigation bar also includes buttons that specify the search criteria of the digital device. For example, the navigation bar could include a subject button. Selection of this button could specify that computer only searches for documents relating to a particular subject. In addition, the navigation could include a type button that limits searching to documents of a particular type. Alternatively, other search criteria could include searching by author, recipient, size or some other suitable criteria. In another alternative embodiment, the navigation bar can include multiple windows for specifying the search criteria.

In addition, the navigation bar can include sub-navigation indicators that enable scrolling from the currently displayed document to the next closest document. For example, the sub-navigation indicators can enable scrolling to the next email message that refers to bananas. The sub-navigation indicators could be arrows, a movable bar within a window, or some other suitable device. In addition, these indicators can be used in conjunction with a host of input devices such as a touch sensitive screen, keyboard, mouse, or voice-activated device.

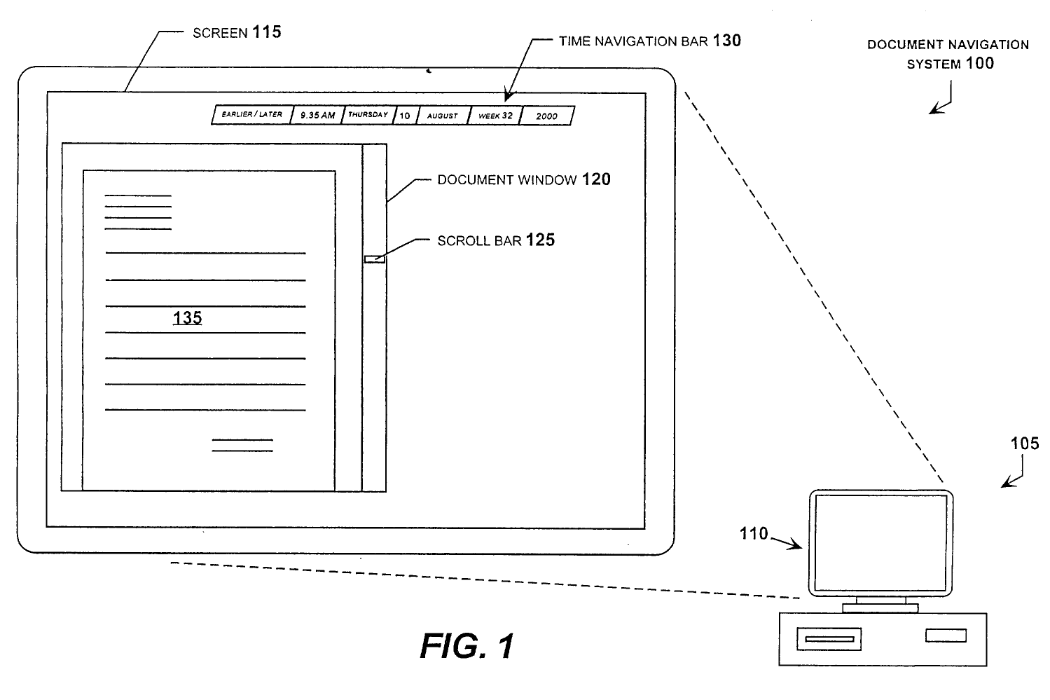

Turning now to the figures, FIG. 1 is a functional block diagram of a document navigation system 100 used with a computer 105. The computer 105 uses a monitor 110 as a display. Within the monitor 110, a screen 115 includes a document window 120 with a scrollbar 125 and a navigation bar 130. The scrollbar 125 enables viewing of a document 135 when the length of this document exceeds the screen area. With the navigation bar 130, a user can request that the document 135 is displayed in the document window 120.

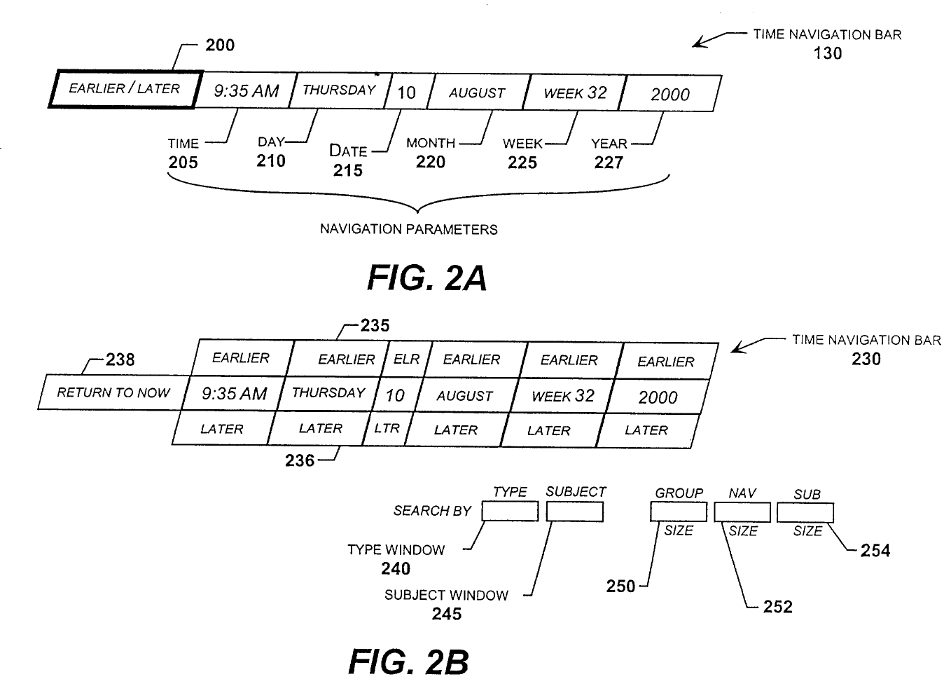

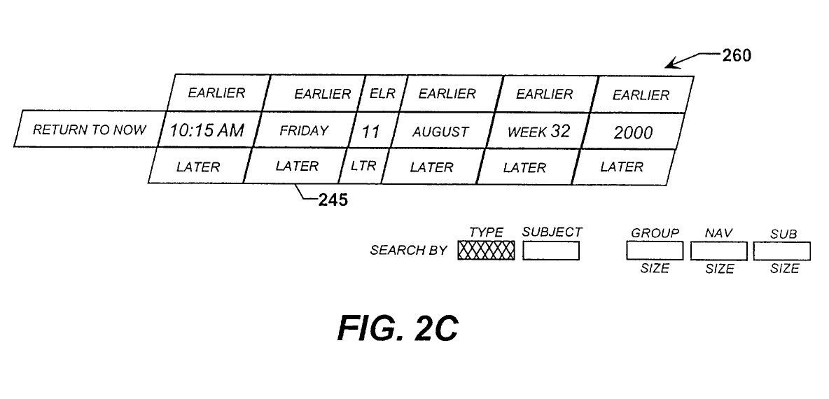

FIG. 2A is a functional block diagram of the navigation bar 130 illustrating navigational parameters that allow user selection of a particular document. The navigation bar 130 can include an earlier/later button 200, a time button 205, a day of the week button 210, a date button 215, a month button 220, a week button 225, and a year button 227. The navigation bar 130 reflects the identification parameters of the document 135 displayed in the document window 120. For example, this document could be an email message sent at 9:35 a.m. on Thursday, Aug. 10, 2000 during the 32^{nd} week of the year.

FIG. 2B is a functional block diagram of an expanded navigation bar 230 that results from selecting the earlier/later button 200. Selection of the earlier/later button 200 produces the navigation bar 230 by enlarging the navigation bar 130 and adding earlier buttons 235 and later buttons 236 for each of the navigation parameters. These buttons are described with reference to FIG. 2C. To collapse the expanded time navigation bar 230, a user can select the return to now button 238. Selecting this button returns the navigation bar 230 to the size of the navigation bar 130 and uses less space in the screen 115. In addition, the expanded navigation bar also includes type window 240, subject window 245, group size window 250, navigation size window 252, and a sub-navigation size window 254. These windows are described in more detail in subsequent figures.

Using either the earlier button 235 or the later button 226, the day of the week can be incremented to Friday or decremented to Thursday. These buttons indicate the navigation direction for each of the navigation parameters. Thus, they can be termed navigation direction indicators. FIG. 2C is a functional block diagram of an expanded navigation bar 260 illustrating the identification parameters displayed after selecting the navigation indicator 236. For example, the navigation bar 230 can display an email message sent at 9:35 a.m. on Thursday, Aug. 10, 2001 during the 32^{nd} week. After selecting the navigation indicator or later button 236, the document window 120 displays an email message sent at 10:15 a.m. on Friday, Aug. 11, 2000 during the 32^{nd} week of the year. Using the navigation indicators, a user can vary navigation parameters and display a closest-fit document in the document window 120 that whose identification parameters correspond closely to the previously displayed document.

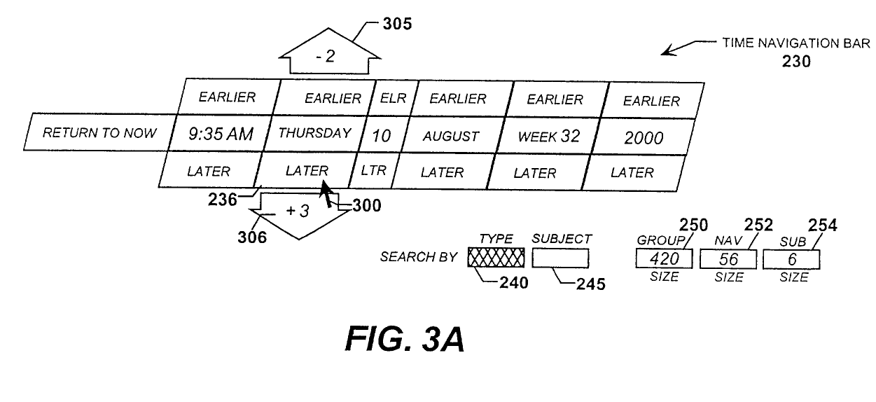

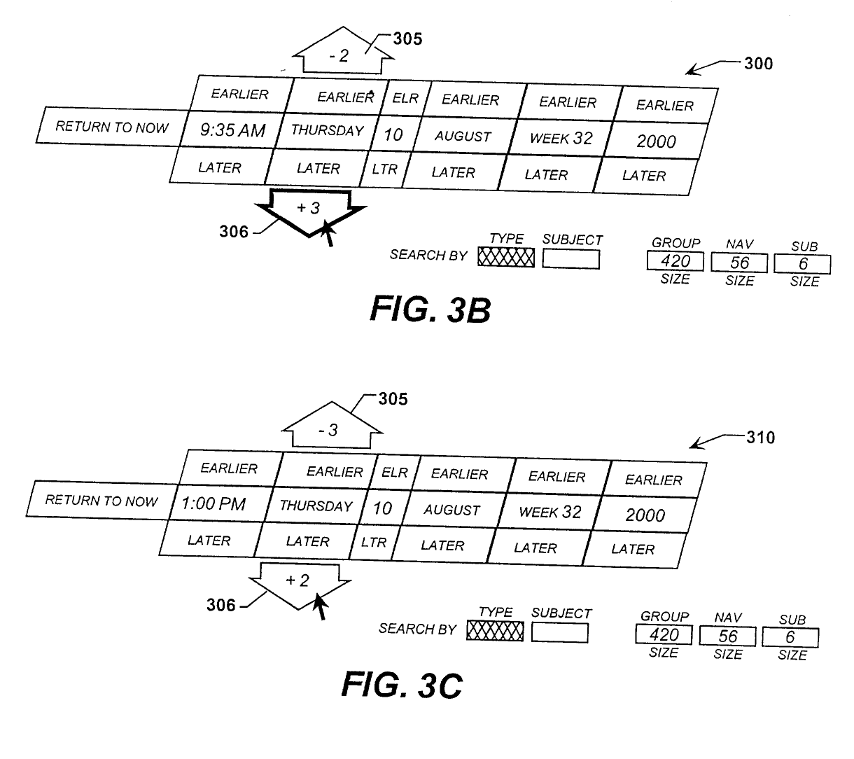

FIG. 3A is a functional block diagram of the expanded time navigation bar 230 illustrating sub-navigation indicators. Using either the type window 240 or subject window 245, users can specify search criteria. The shading in the type window 240 indicates that the computer 105 will search for documents of the same document type as the currently displayed document. For example, the document 135 displayed in the document window 120 and described by the values in the navigation bar 130 could correspond to an email message sent at 9:35 a.m. on Thursday, Aug. 10, 2000 during the 32^{nd} week of the year. By selecting the type box, subsequent searches return only email messages because that is the document type of the currently displayed message.

Using size windows, the computer 105 can display the number of documents that satisfy the search query. As mentioned above, the computer 105 stores data in a data management system, such as a database. The group size window 250 indicates the number of documents within the data management system that satisfy the specified designated type criteria. Using the previous example, the number 420 in the group size window 250 indicates that there are 420 email messages in the data management system.

In addition, the navigation size window 252 indicates the number of documents available for the particular navigation parameter being assessed. For the example illustrated in FIG. 3A, the user selected the day of the week parameter by positioning cursor 300 on the later button 236. Thus, the number 56 in the navigation size window 252 indicates that only fifty-six of the 452 email messages are accessible using the day of the week navigation parameter. A user can access the remaining email messages using some of the other navigation parameters such as the month, week, year, time, or date.

Similarly, the sub-navigation size window 254 indicates the number of documents available within the data management system of the computer 105 accessible from the present value of the navigation parameter. Using the same example, the present value of the day of the week is Thursday. Thus, the number 6 in the sub-navigation size window 254 indicates that the computer's data management system includes six email messages received on Thursday. Together, the size windows specify the relation of the currently displayed document to other documents in the data management system.

Sub-navigation indicators 305, 306 indicate the position of the currently displayed document relative to all the documents in the sub-navigation size. As mentioned above, the sub-navigation size window 254 indicates that six email messages were received on Thursday. Because the values in the time navigation bar 230 represent the identification parameters for a displayed document 135, the values illustrated in FIG. 3A represent one of the six email messages received on Thursday. Hence, selecting the sub-navigation indicator 305 scrolls back to email messages received before the currently displayed messages. Likewise, selection the sub-navigation indicator 306 scrolls to email messages received after the currently displayed message. Though shown with the day of the week parameter, each of the navigation parameters have sub-navigation indicators.

FIG. 3B is a functional block diagram of an expanded time navigation bar 300 illustrating selection of the sub-navigation indicator 306. By selecting this sub-navigation indicator, a user can view an email message received after the currently displayed message. FIG. 3C is a functional block diagram of an expanded navigation bar 310 illustrating the properties of a subsequent email message. For example, the time navigation parameter in the navigation bar 310 indicates that the message was received at 1:00 p.m. on Thursday, which is later than the message associated with the time navigation bar 300. In addition, the numbers on the sub-navigation indicators 305, 306 changed as the navigation parameters changed. As the time changes from 9:35 a.m. to 1:00 p.m., the sub-navigation indicator 305 changes from −2 to −3. Similarly, sub-navigation indicator 306 changes from +3 to +2. This change confirms that the document displayed in the document window 120 corresponds to an email message sent at 1:00 p.m. on Thursday, Aug. 10, 2000 during the 32^{nd} nd week of the year. Using the sub-navigation indicators, user can remain aware of the relation of the currently displayed documents to similar documents.

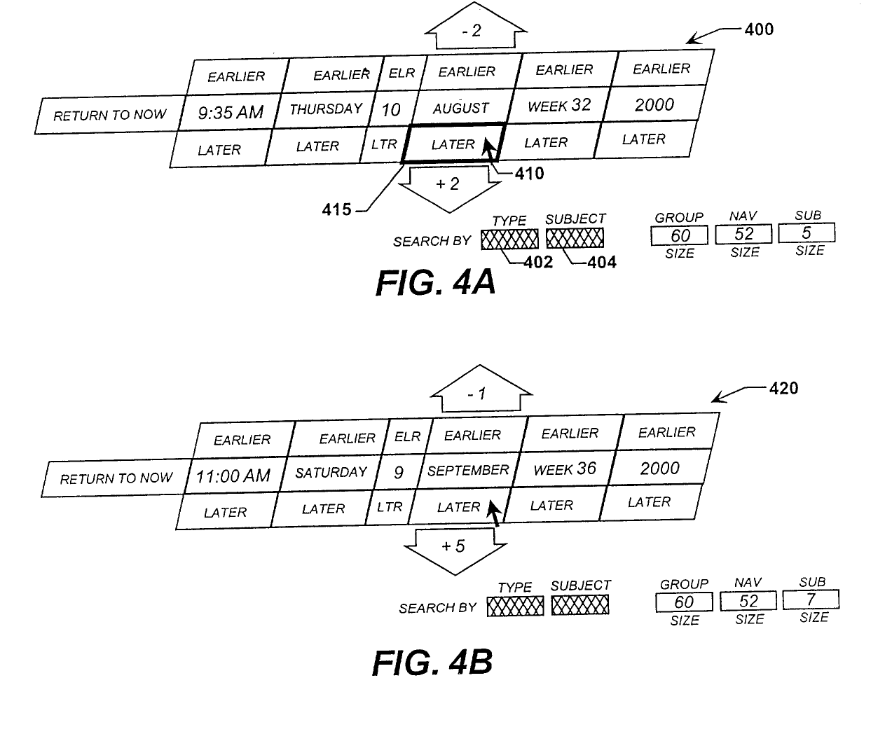

FIG. 4A is a functional block diagram of an expanded time navigation bar 400 illustrating the results of a document type and document subject search. The time navigation bar 400 includes a type search window 402 and a subject search window 404. By selecting these windows, a user can specify that the retrieved documents have the same document type and subject as the document currently displayed in the document window 120. These documents can be referred to as closest-fit documents. For example, specifying the type and subject can result in retrieving only email messages with banana as a subject.

In addition, the navigation indicators and sub-navigation indicators can also be used in type-subject searches. Initially, the computer 105 completes a type-subject search that produces 60 documents in the group size window, 52 documents in the number available (NAV) window, and 5 documents in the subgroup size window. Using the cursor 510, a user can select the navigation indicator 415. FIG. 4B is a functional block diagram of an expanded time navigation bar 420 illustrating the result of selecting the navigation indicator 415. Selecting this navigation indicator changes the month from August to September, which can affect remaining navigation parameters. For example, the document displayed by the time navigation bar 420 could be an email message about bananas received on Saturday, Sep. 9, 2000 during the 36^{th} week of the year. The search that retrieved this document indicates that there are 60 documents in the group window, 52 documents in the number available window, and 7 documents in the subgroup window. This indicates that seven email messages referred to bananas during September 2000. Consequently, a user can navigate the data management system more effectively.

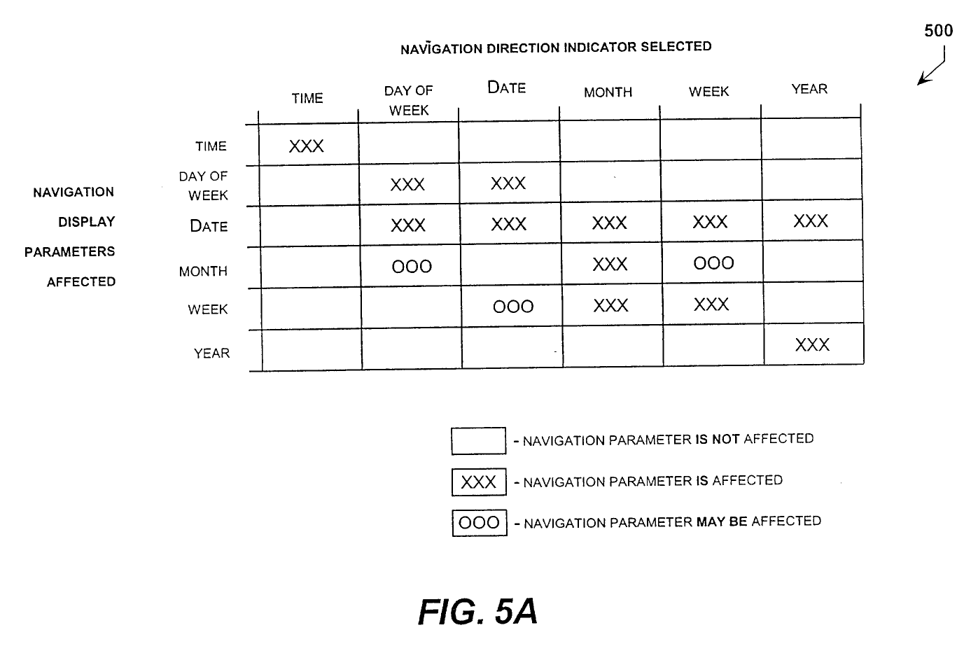

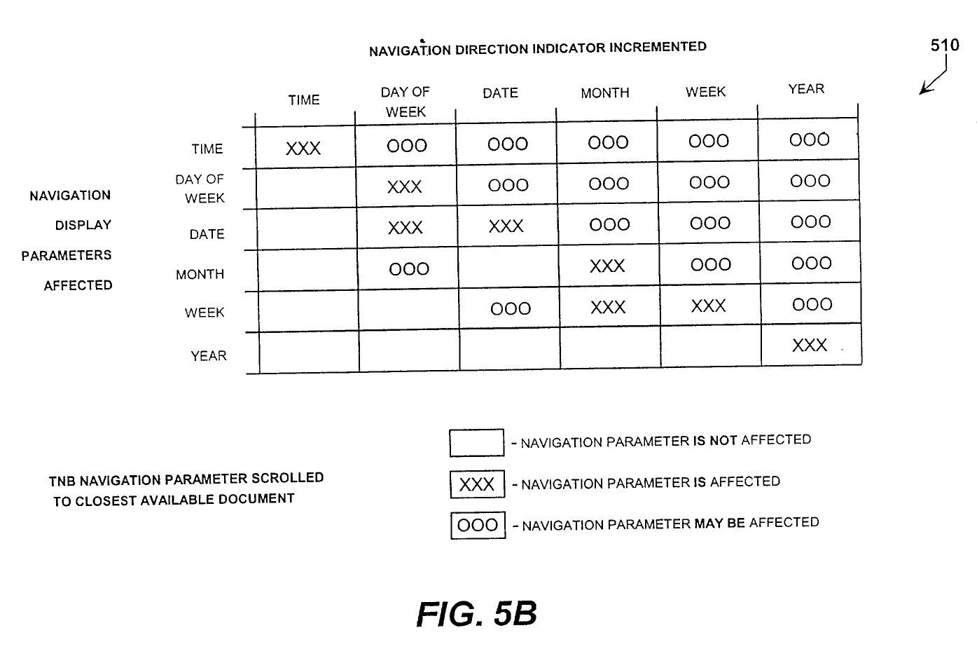

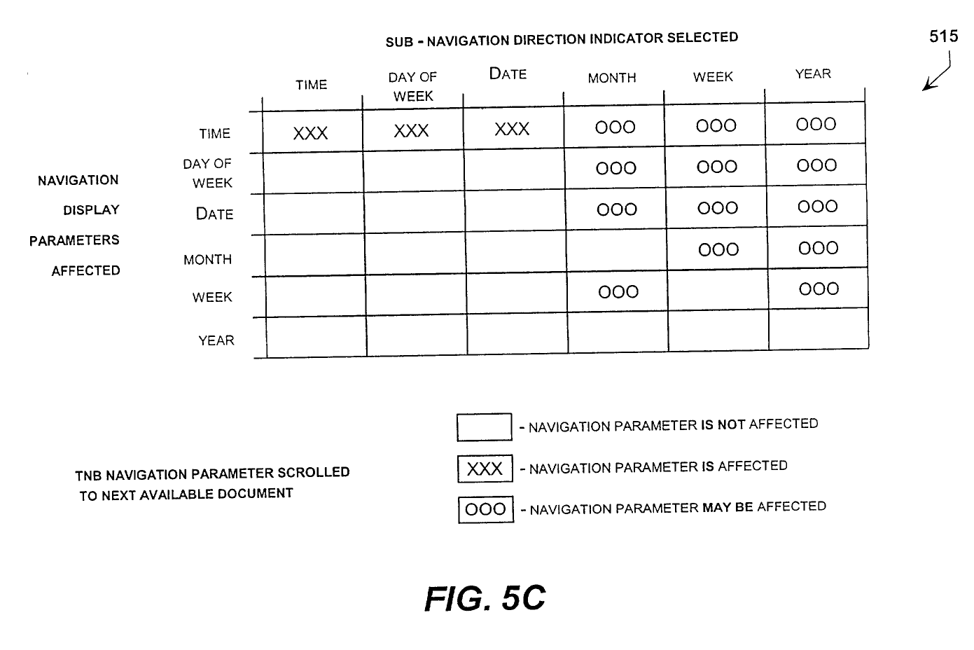

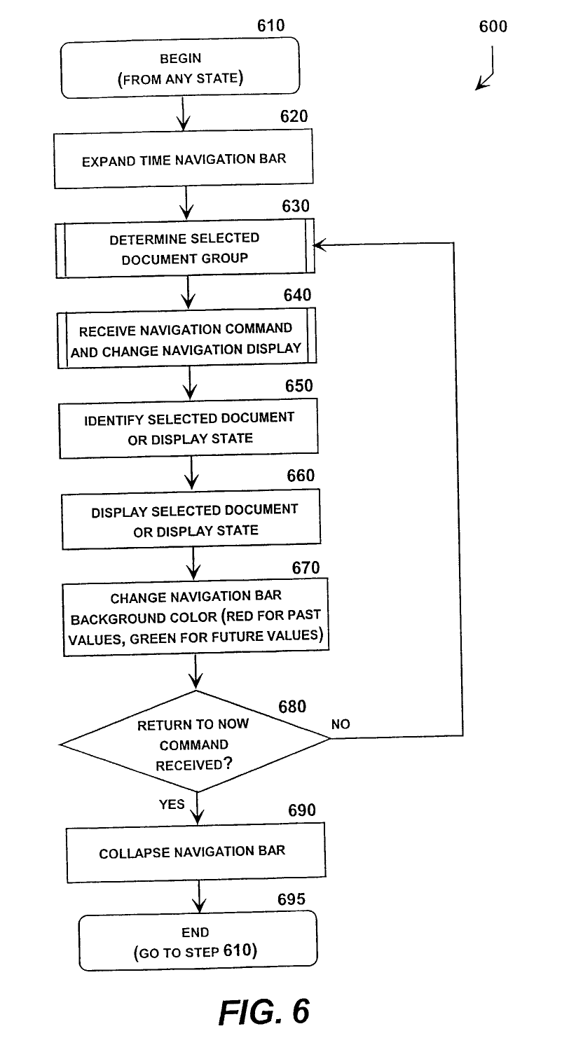

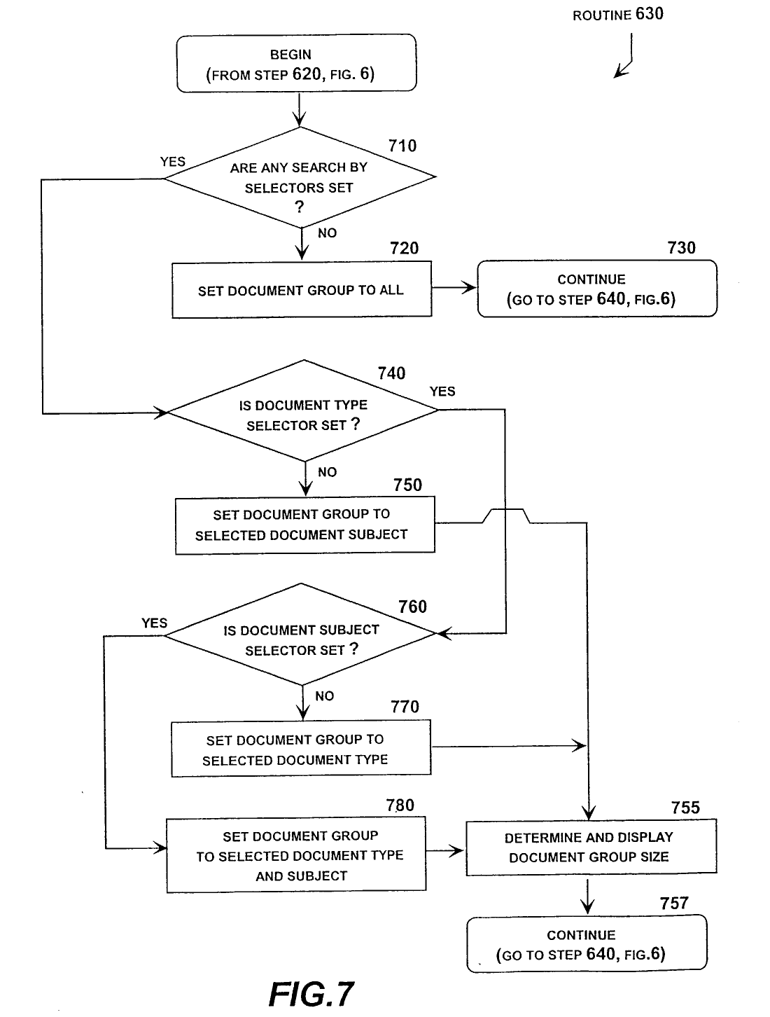

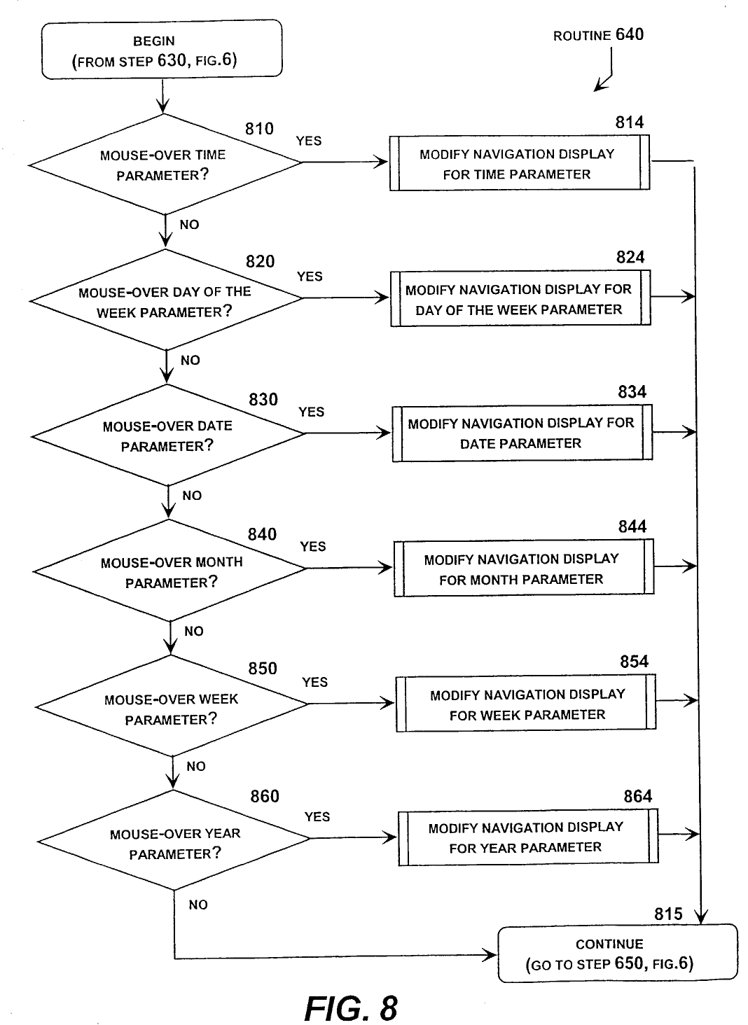

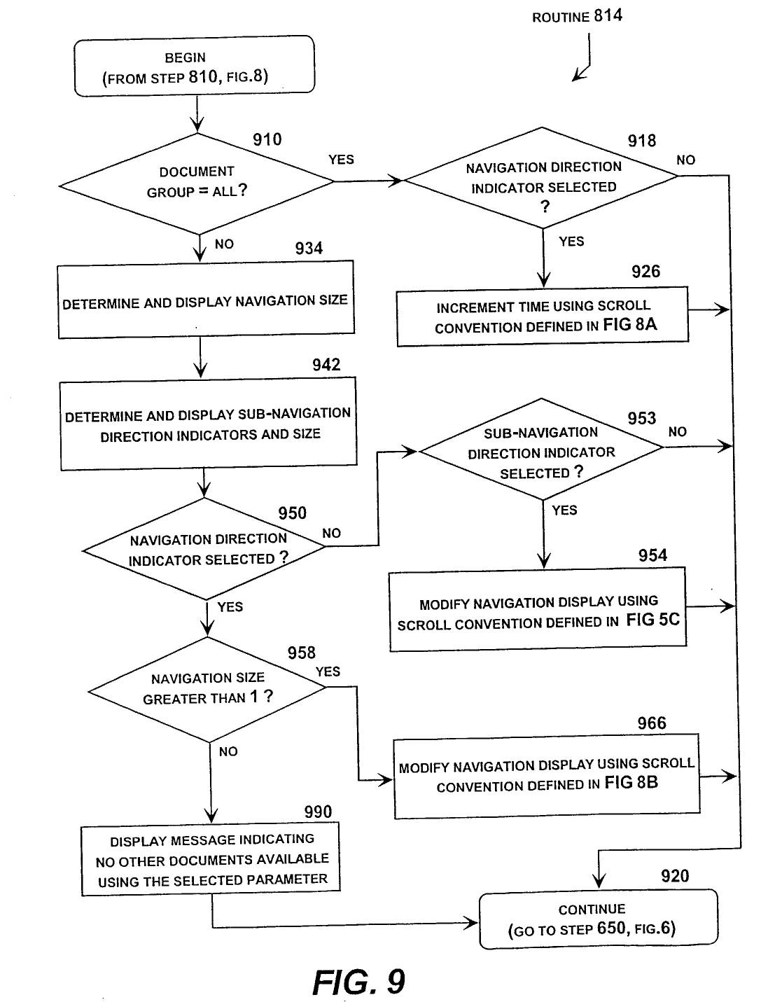

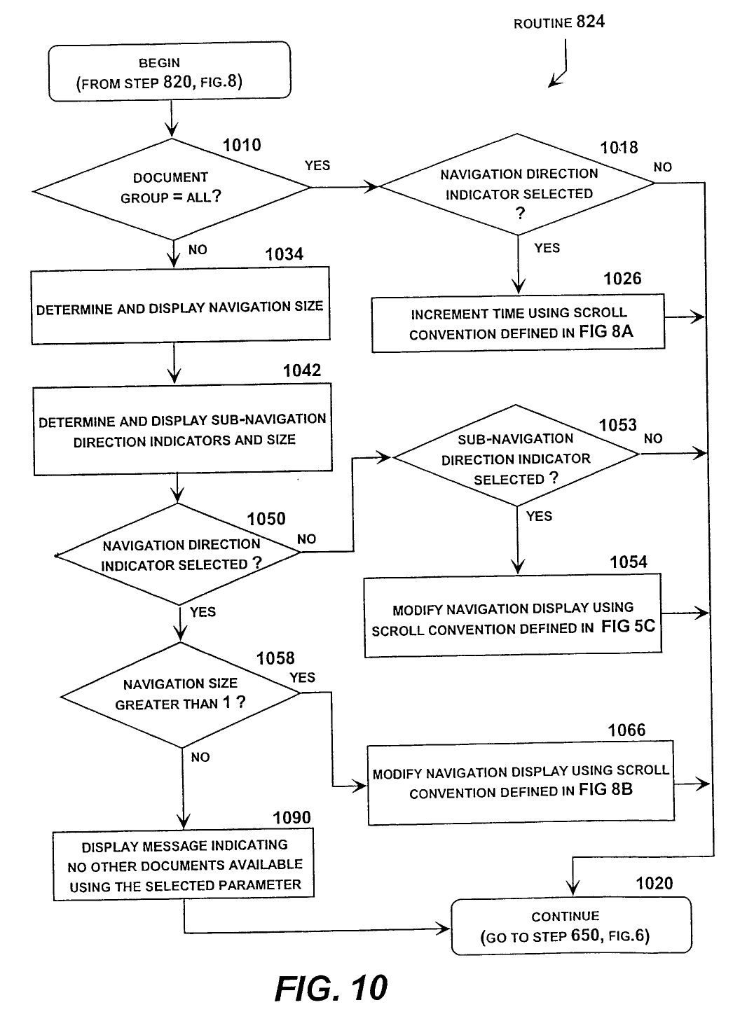

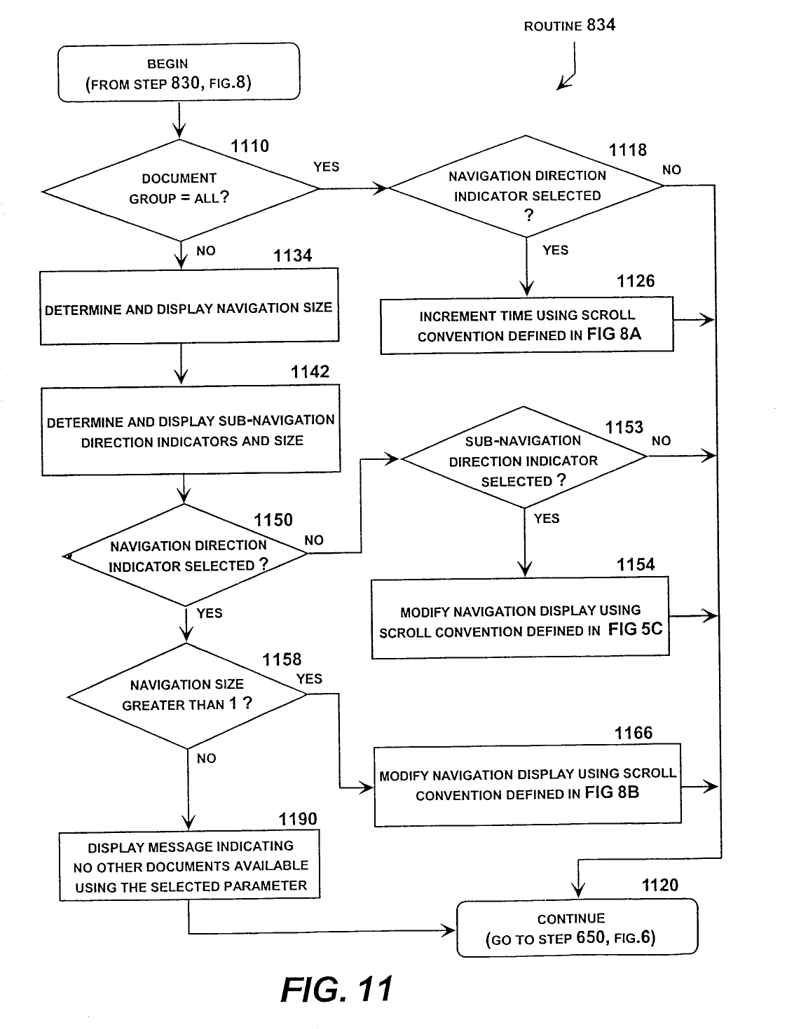

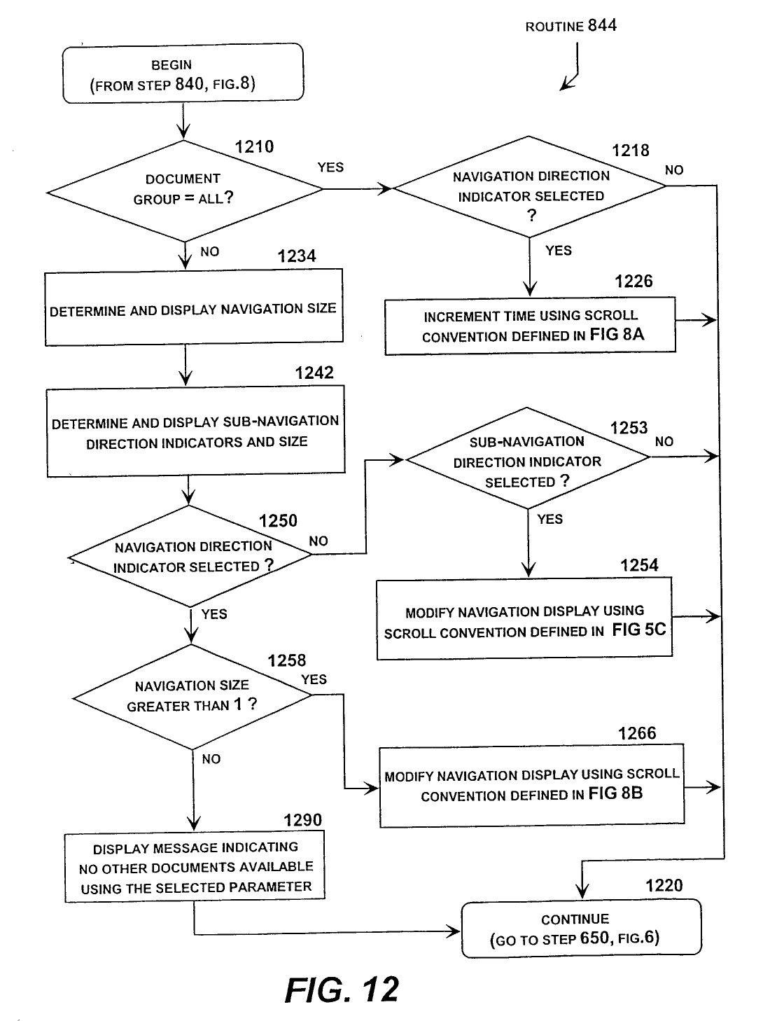

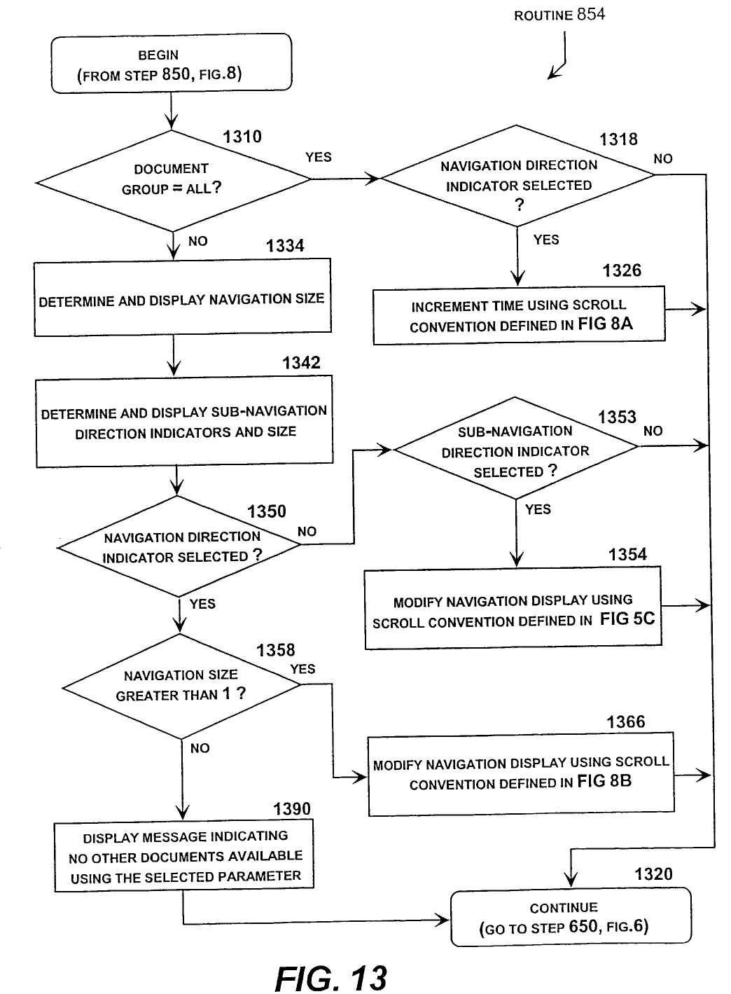

FIG. 5A is a table 500 illustrating the relationship of various navigation parameters as a navigation indicator varies one navigation parameter. For example, a user can select either an earlier button or a later button. As indicated in the table legend, a blank box indicates a parameter is not affected. The presence of XXX in a box indicates that the parameter is affected, while the presence of OOO in the box indicates that a parameter may be affected. Varying the time navigation parameter only affects the time navigation parameter. In contrast, incrementing the day of the week parameter affects date. The month may be affected, while time, day, and year are not affected. Incrementing the date affects the day of the week and may affect the week. However, the time, month, and year are not affected. Incrementing the month varies date and week, but not the time, day, and year. Varying the week changes the date but may not change the month. The time, day of the week, and year are not affected. Incrementing the year only changes the year and the date. Hence, the relationships depicted in the table 500 govern the values displayed in the time navigation bar.

FIG. 5B is a table 510 illustrating the relationship of various navigation parameters as scrolling to the next available document varies a navigation indicator. The navigation parameter is scrolled to the next available document. Scrolling to the next available document for the time navigation parameter does not affect any other navigation parameter. For the day of the week parameter, the date and day of the week are affected, while the time and month may be affected. However, varying the day of the week does not vary the week or the year navigation parameter. For the date parameter, fhe time, day of the week, and week may be affected. The month and the year are not affected. As the month is scrolled, the week is affected and the time, day of the week, and date may be affected. The year is not affected. As the week parameter is scrolled, the year is not affected and the remaining parameters may be affected. As the year parameter is scrolled, all navigation parameters may be affected.

FIG. 5C is a table 515 illustrating the relationship of various navigation parameters, as one navigation parameter is scrolled to the next available document using a sub-navigation direction indicator. For example, a user can select an up arrow or a down arrow. As the time parameter is scrolled, the remaining navigation parameters do not change. The day of the week and date parameter behave similarly. For the month parameter, the year and month are not affected while the remaining parameters may be affected. As the week parameter is scrolled, the week and year are not affected and the remaining parameters may be affected. For the year parameter, the year is not affected and all remaining parameters may be affected. Together tables 510-515 define the relationship among the navigation parameters. The functions of these tables are described with reference to subsequent flow diagrams.

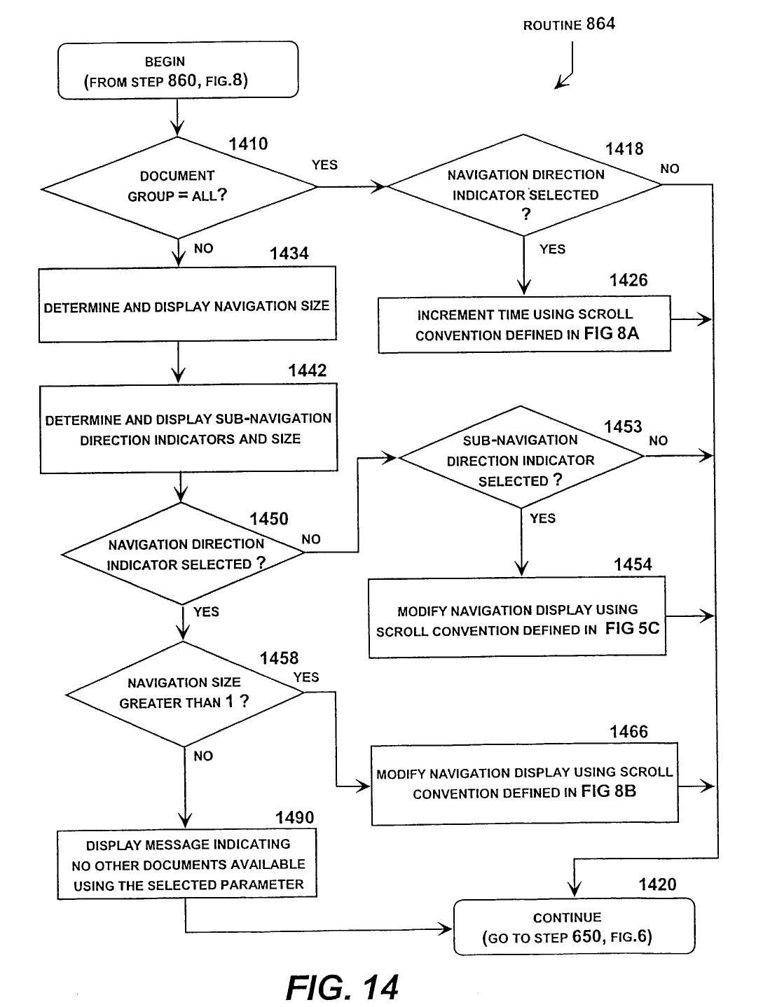

FIG. 6 is a flow diagram of a routine 600 that controls the document navigation system 100. In step 610, the routine 600 begins. Step 610 is followed by step 620, in which the routine 600 expands the time navigation bar. Often a user request prompts expansion of the time navigation bar. For example, a user can select the earlier/later button 200 described with reference to FIG. 2A. Step 620 is followed by subroutine 630, in which the routine 600 determines the selected document group. This subroutine is described in greater detail with reference to FIG. 7. Step 630 is followed by subroutine 640, in which the routine 600 receives a navigation command and changes the navigational display. This subroutine is described in greater detail with reference to FIG. 8.

Step 640, is followed by step 650, in which the routine 600 identifies the selected document or displays the state. Generally, the state corresponds to the values of the navigation parameters for a particular document, or identification parameters used in searching. Step 650 is followed by step 660 in which the routine 600 displays the selected document or selected state. Typically, the document is displayed in the document window 120. Step 660 is followed by step 670 in which the routine 600 changes the navigation bar background color. For example, the color red can represent past values and the color green can represent future values. Using color designations can enable easier association of information.

Step 670 is followed by step 680 in which the routine 600 determines if a return to now command was received. As a user selects the return to now button 238 shown in FIG. 2B, the document navigation system issues a return to now command. If the return to now command was not received, the routine 600 returns to step 630 and determines the selected document group. Otherwise, step 680 is followed by step 690 in which the routine 600 collapses the navigation bar. Step 690 is followed by step 695 in which the routine 600 ends. After receiving a user command, the routine 600 can return to step 610.

FIG. 7 is a flow diagram illustrating the subroutine 630 for determining the selected document group. The routine 630 begins from step 620 shown on FIG. 6. In step 710, the routine 630 decides if any “search by” selectors are set. Search by selectors include search by document type and search by document subject criteria. If no selectors are set, step 710 is followed by step 720 in which the routine 630 sets the document group to all. This setting enables scrolling through all of the documents in the data management system. Step 720 is followed by the continue step 730 in which the routine 630 returns to step 640 on FIG. 6.

If search by selectors are set, the “YES” branch is followed from step 710 to step 740. In step 740, the routine 630 decides if a document type selector is set. For example, the subroutine 630 determines if a user requested only email messages. If a document selector is not set, the “NO” branch is followed from step 740 to step 750. In step 750, the routine 630 sets the document group to selected document subject. For example, the routine 630 will search for documents on bananas. Step 750 is followed by step 755, in which the routine 630 determines and displays the document group size. Step 755 is followed by the CONTINUE step 757, in which the routine 630 returns to step 640 on FIG. 6.

If a document type selector is set, the “YES” branch is followed from step 740 to step 760. In step 760, the routine 630 decides if the document subject selector is set. If the document subject selector is not set, the “NO” branch is followed from step 760 to step 770. In step 770, the routine 630 sets the document group to the selected document type. Step 770 is followed by step 755 in which the routine 630 determines and displays the document group size. If the document subject selector is set, the “YES” branch is followed from step 760 to step 780. In step 780, the routine 630 sets the document to the selected document type and subject. Hence, the documents are searched for both a designated document type and subject. Step 780 is followed by step 755, in which the routine 630 determines and displays the document group size.

FIG. 8 is a flow diagram illustrating the subroutine 640 of receiving a navigation command and changing the navigation display. The routine 640 begins from step 630 shown on FIG. 6. In step 810, the routine 640 decides if a user positioned the mouse over the time parameter. If the mouse is positioned over the time parameter, the “YES” branch is followed from step 810 to subroutine 814. In subroutine 814, the routine 740 modifies the navigation display for the time parameter. Step 814 is followed by the CONTINUE step 815, in which the routine 640 returns to step 650 shown on FIG. 6.

If the mouse is not positioned over the time parameter, the “NO” branch is followed from step 810 to step 820. In step 820, the routine 640 decides if a user positioned the mouse over the day of week parameter. If the mouse is positioned over the day of week parameter, the “YES” branch is followed from step 820 to subroutine 824. In subroutine 824, the routine 640 modifies the navigation display for the day of the week parameter. Step 824 is followed by the CONTINUE step 815.

If the mouse is not positioned over the week parameter, the “NO” branch is followed from step 820 to step 830. In step 830, the routine 640 decides if a user positioned the mouse over the date parameter. If the mouse is positioned over the date parameter, the “YES” branch is followed from step 830 to subroutine 834. In subroutine 834, the routine 640 modifies the navigation display for the date parameter. Step 834 is followed by the CONTINUE step 815.

If the mouse is not positioned over the date parameter, the “NO” branch is followed from step 830 to step 840. In step 840, the routine 640 decides if a user positioned the mouse over the month parameter. If the mouse is positioned over the date parameter, the “YES” branch is followed from step 840 to subroutine 844. In subroutine 844, the routine 640 modifies the navigation display for the month parameter. Step 844 is followed by the CONTINUE step 815.

If the mouse is not positioned over the month parameter, the “NO” branch is followed from step 840 to step 850. In step 850, the routine 640 decides if a user positioned the mouse over the week parameter. If the mouse is positioned over the week parameter, the “YES” branch is followed from step 850 to subroutine 854. In subroutine 854, the routine 640 modifies the navigation display for the week parameter. Step 854 is followed by the CONTINUE step 815.

If the mouse is not positioned over the week parameter, the “NO” branch is followed from step 850 to step 860. In step 860, the routine 640 decides if a user positioned the mouse over the year parameter. If the mouse is positioned over the year parameter, the “YES” branch is followed from step 860 to subroutine 864. In subroutine 864, the routine 640 modifies the navigation display for the year parameter. Step 854 is followed by the CONTINUE step 815.

FIG. 9 is a flow diagram illustrating the subroutine 814 of modifying the navigation display for the time navigation parameter. Routine 814 begins from step 810 of FIG. 8. In step 910, the routine 814 decides if the document group includes all the documents in the data management system. If the document group is all, the “YES” branch is followed from step 910 to step 918. In step 918, the routine 814 decides if the navigation direction indicator is selected. For example, the routine 814 decides if a user selected an earlier button. If the navigation direction indicator is not selected, the “NO” branch is followed from step 918 to the CONTINUE step 920. In step 920, the routine 814 returns to step 650 shown on FIG. 6. If the navigation direction indicator is selected, the “YES” branch is followed from step 918 to step 926. In step 926, the routine 814 increments the time using the scroll convention indicated in the table 500 on FIG. 5A. Step 926 is followed by the CONTINUE step 920.

If the document group does not include all the documents, the “NO” branch is followed from step 910 to step 934. In step 934, the subroutine 934 determines and displays the navigation size. The navigation size corresponds to the number of documents available in the current day. Step 934 is followed by step 942, in which the routine 814 determines and displays the sub-navigation direction indicators and the sub-navigation size. The sub-navigation size refers to the number of documents available earlier and later in the current day.

Step 942 is followed by step 950, in which the routine 814 decides if the navigation direction indicator is selected. If the navigation direction indicator is not selected, the “NO” branch is followed from step 950 to step 953. In step 953, the routine 814 decides if a user selected the sub-navigation indicator. For example, the routine 814 determines if a user selected the up arrow. If the sub-navigation indicator is not selected the “NO” branch is followed from step 953 to the CONTINUE step 920. If the sub-navigation direction indicator was selected, the “YES” branch is followed from step 953 to step 954. In step 954, the routine 814 modifies the navigation display using the scroll convention illustrated in the table 515 shown in FIG. 5C. This scrolls to the next available document in the day. Step 954 is followed by the CONTINUE step 920.

If the navigation direction indicator was not selected, the “YES” branch is followed from step 950 to step 958. In step 958, the routine 814 decides if the navigation size is greater than 1. If the navigation size is greater than one, the “YES” branch is followed from step 958 to step 966. In step 966, the routine 814 modifies the navigation display using the scroll convention illustrated in the table 510 shown in FIG. 5B. Step 966 is followed by the CONTINUE step 920. If the navigation size is not greater than 1, the “NO” branch is followed from step 958 to step 990. In step 990, the routine 814 displays a message indicating that there is no other documents available using the selected parameter. Step 990 is followed by the CONTINUE step 920.

FIG. 10 is a flow diagram illustrating the subroutine 824 of modifying the navigation display for the day of the week parameter. Routine 824 begins from step 820 of FIG. 8. In step 1010, the routine 824 decides if the document group includes all the documents in the data management system. If the document group is all, the “YES” branch is followed from step 1010 to step 1018. In step 1018, the routine 824 decides if the navigation direction indicator is selected. For example, the routine 824 decides if a user selected an earlier button. If the navigation direction indicator is not selected, the “NO” branch is followed from step 1018 to the CONTINUE step 1020. In step 1020, the routine 824 returns to step 650 shown on FIG. 6. If the navigation direction indicator is selected, the “YES” branch is followed from step 1018 to step 1026. In step 1026, the routine 824 increments the time using the scroll convention indicated in the table 500 on FIG. 5A. Step 1026 is followed by the CONTINUE step 1020.

If the document group does not include all the documents, the “NO” branch is followed from step 1010 to step 1034. In step 1034, the subroutine 1034 determines and displays the navigation size. The navigation size corresponds to the number of documents available in the current day of the week. Step 1034 is followed by step 1042, in which the routine 824 determines and displays the sub-navigation direction indicators and the sub-navigation size. The sub-navigation size refers to the number of documents available earlier and later in the current day of the week.

Step 1042 is followed by step 1050, in which the routine 824 decides if the navigation direction indicator is selected. If the navigation direction indicator is not selected, the “NO” branch is followed from step 1050 to step 1053. In step 1053, the routine 824 decides if a user selected the sub-navigation indicator. For example, the routine 824 determines if a user selected the up arrow. If the sub-navigation indicator is not selected the “NO” branch is followed from step 1053 to the CONTINUE step 1020. If the sub-navigation direction indicator was selected, the “YES” branch is followed from step 1053 to step 1054. In step 1054, the routine 824 modifies the navigation display using the scroll convention illustrated in the table 515 shown in FIG. 5C. This scrolls to the next available document in the day of week. Step 1054 is followed by the CONTINUE step 1020.

If the navigation direction indicator was not selected, the “YES” branch is followed from step 1050 to step 1058. In step 1058, the routine 824 decides if the navigation size is greater than 1. If the navigation size is greater than one, the “YES” branch is followed from step 1058 to step 1066. In step 1066, the routine 824 modifies the navigation display using the scroll convention illustrated in the table 510 shown in FIG. 5B. Step 1066 is followed by the CONTINUE step 1020. If the navigation size is not greater than 1, the “NO” branch is followed from step 1058 to step 1090. In step 1090, the routine 824 displays a message indicating that there is no other documents available using the selected parameter. Step 1090 is followed by the CONTINUE step 1020.

FIG. 11 is a flow diagram illustrating the subroutine 834 of modifying the navigation display for the date navigation parameter. Routine 834 begins from step 830 of FIG. 8. In step 1110, the routine 834 decides if the document group includes all the documents in the data management system. If the document group is all, the “YES” branch is followed from step 1110 to step 1118. In step 1118, the routine 834 decides if the navigation direction indicator is selected. For example, the routine 834 decides if a user selected an earlier button. If the navigation direction indicator is not selected, the “NO” branch is followed from step 1118 to the CONTINUE step 1120. In step 1120, the routine 834 returns to step 650 shown on FIG. 6. If the navigation direction indicator is selected, the “YES” branch is followed from step 1118 to step 1126. In step 1126, the routine 834 increments the time using the scroll convention indicated in the table 500 on FIG. 5A. Step 1126 is followed by the CONTINUE step 1120.

If the document group does not include all the documents, the “NO” branch is followed from step 1110 to step 1134. In step 1134, the subroutine 1134 determines and displays the navigation size. The navigation size corresponds to the number of documents available in the current date. Step 1134 is followed by step 1142, in which the routine 834 determines and displays the sub-navigation direction indicators and the sub-navigation size. The sub-navigation size refers to the number of documents available earlier and later in the current date.

Step 1142 is followed by step 1150, in which the routine 834 decides if the navigation direction indicator is selected. If the navigation direction indicator is not selected, the “NO” branch is followed from step 1150 to step 1153. In step 1153, the routine 834 decides if a user selected the sub-navigation indicator. For example, the routine 834 determines if a user selected the up arrow. If the sub-navigation indicator is not selected the “NO” branch is followed from step 1153 to the CONTINUE step 1120. If the sub-navigation direction indicator was selected, the “YES” branch is followed from step 1153 to step 1154. In step 1154, the routine 834 modifies the navigation display using the scroll convention illustrated in the table 515 shown in FIG. 5C. This scrolls to the next available document in the date. Step 1154 is followed by the CONTINUE step 1120.

If the navigation direction indicator was not selected, the “YES” branch is followed from step 1150 to step 1158. In step 1158, the routine 834 decides if the navigation size is greater than 1. If the navigation size is greater than one, the “YES” branch is followed from step 1158 to step 1166. In step 1166, the routine 834 modifies the navigation display using the scroll convention illustrated in the table 510 shown in FIG. 5B. Step 1166 is followed by the CONTINUE step 1120. If the navigation size is not greater than 1, the “NO” branch is followed from step 1158 to step 1190. In step 1190, the routine 834 displays a message indicating that there is no other documents available using the selected parameter. Step 1190 is followed by the CONTINUE step 1120.

FIG. 12 is a flow diagram illustrating the subroutine 844 of modifying the navigation display for the month navigation parameter. Routine 844 begins from step 830 of FIG. 8. In step 1210, the routine 844 decides if the document group includes all the documents in the data management system. If the document group is all, the “YES” branch is followed from step 1210 to step 1218. In step 1218, the routine 844 decides if the navigation direction indicator is selected. For example, the routine 844 decides if a user selected an earlier button. If the navigation direction indicator is not selected, the “NO” branch is followed from step 1218 to the CONTINUE step 1220. In step 1220, the routine 844 returns to step 650 shown on FIG. 6. If the navigation direction indicator is selected, the “YES” branch is followed from step 1218 to step 1226. In step 1226, the routine 844 increments the time using the scroll convention indicated in the table 500 on FIG. 5A. Step 1226 is followed by the CONTINUE step 1220.

If the document group does not include all the documents, the “NO” branch is followed from step 1210 to step 1234. In step 1234, the subroutine 1234 determines and displays the navigation size. The navigation size corresponds to the number of documents available in the current month. Step 1234 is followed by step 1242, in which the routine 844 determines and displays the sub-navigation direction indicators and the sub-navigation size. The sub-navigation size refers to the number of documents available earlier and later in the current month.

Step 1242 is followed by step 1250, in which the routine 844 decides if the navigation direction indicator is selected. If the navigation direction indicator is not selected, the “NO” branch is followed from step 1250 to step 1253. In step 1253, the routine 844 decides if a user selected the sub-navigation indicator. For example, the routine 844 determines if a user selected the up arrow. If the sub-navigation indicator is not selected the “NO” branch is followed from step 1253 to the CONTINUE step 1220. If the sub-navigation direction indicator was selected, the “YES” branch is followed from step 1253 to step 1254. In step 1254, the routine 844 modifies the navigation display using the scroll convention illustrated in the table 515 shown in FIG. 5C. This scrolls to the next available document in the month. Step 1254 is followed by the CONTINUE step 1220.

If the navigation direction indicator was not selected, the “YES” branch is followed from step 1250 to step 1258. In step 1258, the routine 844 decides if the navigation size is greater than 1. If the navigation size is greater than one, the “YES” branch is followed from step 1258 to step 1266. In step 1266, the routine 844 modifies the navigation display using the scroll convention illustrated in the table 510 shown in FIG. 5B. Step 1266 is followed by the CONTINUE step 1220. If the navigation size is not greater than 1, the “NO” branch is followed from step 1258 to step 1290. In step 1290, the routine 844 displays a message indicating that there is no other documents available using the selected parameter. Step 1290 is followed by the CONTINUE step 1220.

FIG. 13 is a flow diagram illustrating the subroutine 844 of modifying the navigation display for the week navigation parameter. Routine 844 begins from step 830 of FIG. 8. In step 1310, the routine 844 decides if the document group includes all the documents in the data management system. If the document group is all, the “YES” branch is followed from step 1310 to step 1318. In step 1318, the routine 844 decides if the navigation direction indicator is selected. For example, the routine 844 decides if a user selected an earlier button. If the navigation direction indicator is not selected, the “NO” branch is followed from step 1318 to the CONTINUE step 1320. In step 1320, the routine 844 returns to step 650 shown on FIG. 6. If the navigation direction indicator is selected, the “YES” branch is followed from step 1318 to step 1326. In step 1326, the routine 844 increments the time using the scroll convention indicated in the table 500 on FIG. 5A. Step 1326 is followed by the CONTINUE step 1320.

If the document group does not include all the documents, the “NO” branch is followed from step 1310 to step 1334. In step 1334, the subroutine 1334 determines and displays the navigation size. The navigation size corresponds to the number of documents available in the current week. Step 1334 is followed by step 1342, in which the routine 844 determines and displays the sub-navigation direction indicators and the sub-navigation size. The sub-navigation size refers to the number of documents available earlier and later in the current week.

Step 1342 is followed by step 1350, in which the routine 844 decides if the navigation direction indicator is selected. If the navigation direction indicator is not selected, the “NO” branch is followed from step 1350 to step 1353. In step 1353, the routine 844 decides if a user selected the sub-navigation indicator. For example, the routine 844 determines if a user selected the up arrow. If the sub-navigation indicator is not selected the “NO” branch is followed from step 1353 to the CONTINUE step 1320. If the sub-navigation direction indicator was selected, the “YES” branch is followed from step 1353 to step 1354. In step 1354, the routine 844 modifies the navigation display using the scroll convention illustrated in the table 515 shown in FIG. 5C. This scrolls to the next available document in the week. Step 1354 is followed by the CONTINUE step 1320.

If the navigation direction indicator was not selected, the “YES” branch is followed from step 1350 to step 1358. In step 1358, the routine 844 decides if the navigation size is greater than 1. If the navigation size is greater than one, the “YES” branch is followed from step 1358 to step 1366. In step 1366, the routine 844 modifies the navigation display using the scroll convention illustrated in the table 510 shown in FIG. 5B. Step 1366 is followed by the CONTINUE step 1320. If the navigation size is not greater than 1, the “NO” branch is followed from step 1358 to step 1390. In step 1390, the routine 844 displays a message indicating that there is no other documents available using the selected parameter. Step 1390 is followed by the CONTINUE step 1320.

FIG. 14 is a flow diagram illustrating the subroutine 854 of modifying the navigation display for the year navigation parameter. Routine 854 begins from step 830 of FIG. 8. In step 1410, the routine 854 decides if the document group includes all the documents in the data management system. If the document group is all, the “YES” branch is followed from step 1410 to step 1418. In step 1418, the routine 854 decides if the navigation direction indicator is selected. For example, the routine 854 decides if a user selected an earlier button. If the navigation direction indicator is not selected, the “NO” branch is followed from step 1418 to the CONTINUE step 1420. In step 1420, the routine 854 returns to step 650 shown on FIG. 6. If the navigation direction indicator is selected, the “YES” branch is followed from step 1418 to step 1426. In step 1426, the routine 854 increments the time using the scroll convention indicated in the table 500 on FIG. 5A. Step 1426 is followed by the CONTINUE step 1420.

If the document group does not include all the documents, the “NO” branch is followed from step 1410 to step 1434. In step 1434, the subroutine 1434 determines and displays the navigation size. The navigation size corresponds to the number of documents available in the current year. Step 1434 is followed by step 1442, in which the routine 854 determines and displays the sub-navigation direction indicators and the sub-navigation size. The sub-navigation size refers to the number of documents available earlier and later in the current year.

Step 1442 is followed by step 1450, in which the routine 854 decides if the navigation direction indicator is selected. If the navigation direction indicator is not selected, the “NO” branch is followed from step 1450 to step 1453. In step 1453, the routine 854 decides if a user selected the sub-navigation indicator. For example, the routine 854 determines if a user selected the up arrow. If the sub-navigation indicator is not selected the “NO” branch is followed from step 1453 to the CONTINUE step 1420. If the sub-navigation direction indicator was selected, the “YES” branch is followed from step 1453 to step 1454. In step 1454, the routine 854 modifies the navigation display using the scroll convention illustrated in the table 515 shown in FIG. 5C. This scrolls to the next available document in the year. Step 1454 is followed by the CONTINUE step 1420.

If the navigation direction indicator was not selected, the “YES” branch is followed from step 1450 to step 1458. In step 1458, the routine 854 decides if the navigation size is greater than 1. If the navigation size is greater than one, the “YES” branch is followed from step 1458 to step 1466. In step 1466, the routine 854 modifies the navigation display using the scroll convention illustrated in the table 510 shown in FIG. 5B. Step 1466 is followed by the CONTINUE step 1420. If the navigation size is not greater than 1, the “NO” branch is followed from step 1458 to step 1490. In step 1490, the routine 854 displays a message indicating that there is no other documents available using the selected parameter. Step 1490 is followed by the CONTINUE step 1420.

In view of the foregoing, it will be appreciated that present invention provides a document navigation system for effective identification and display of a document. Using navigation parameters such as time, day, date, month, week, and year, users can easily scroll through documents from the document window within a single document window. Moreover, size information such as group size, number available, and subgroup size provides addition information regarding the location of additional documents associated with the currently displayed document. It should be understood that the foregoing relates only to the exemplary embodiments of the present invention, and that numerous changes may be made therein without departing from the spirit and scope of the invention as defined by the following claims.

The invention claimed is:

1. A method for identifying and displaying documents within a computer-based document management system, each document having a defined set of identification parameters, comprising the steps of:
providing a document viewing window for displaying all or a portion of one or more of the documents;
providing a control item comprising a plurality of selectable time-based navigation parameters;
receiving input commands setting the navigation parameters to define time-based document selection criteria;
identifying a closest-fit document having identification parameters that most closely correspond to the document selection criteria; and
displaying all or a portion of the closest-fit document in the document window.

2. The method of claim 1 further comprising the steps of:
updating the navigation parameters to reflect the identification parameters of the closest-fit document; and
displaying the updated navigation parameters in connection with the control item.

3. The method of claim 1 further comprising the steps of:
identifying a group of documents corresponding to a selected one of the navigation parameters;
identifying a sub-group among the group of documents for the selected navigation parameters, the sub-group comprising documents corresponding to a current setting of the selected navigation parameter;
displaying a sub-navigation parameter in association with the selected navigation parameter identifying the number of documents in the sub-group and allowing selection among the documents in the sub-group;
receiving an input command selecting a sub-group document; and
displaying all or a portion of the selected document in the document window.

4. The method of claim 3 further comprising steps of:
displaying upon the control item the total number of documents available within the group of documents corresponding to the selected navigation parameter; and
displaying upon the control item the total number of documents available in the sub-group which corresponds to the current setting of the selected navigation parameter.

5. The method of claim 1 further comprising the steps of:
providing an additional non time-based document selection criteria, the criteria comprising documents of the same document type as the current closest-fit document;
receiving input commands enabling the document type criteria; and
limiting the available range of closest-fit documents to only those of the same document type.

6. The method of claim 5 further comprising the steps of identifying and displaying upon the control item, the total number of documents available within the document management system that satisfy the non time-based document selection criteria.

7. The method of claim 1 further comprising the steps of:
providing an additional non time-based document selection criteria, the criteria comprising documents of the same document subject as the current closest-fit document;
receiving input commands enabling the document subject criteria; and
limiting the available range of closest fit documents to only those of the same document subject.

8. The method of claim 1 further comprising the steps of:
providing additional non time-based document selection criteria, the criteria comprising documents of the same document subject and document type as the current closest-fit document;
receiving input commands enabling the document subject and document type criteria; and
limiting the available range of closest-fit documents to only those of the same document subject and document type.

9. The method of claim 1 further comprising the steps of:
displaying at least one directional parameter associated with the selection criteria upon the control item;
receiving a directional input command that indicates a second closest-fit document that should be displayed in the document window; and
displaying all or a portion of the second closest-fit document in the document window in response to receiving the directional input command.

10. The method of claim 1 wherein the time-based navigation parameters include a navigation parameter selected from the group consisting of year of creation of the document, week of creation of the document, month of creation of the document, time of creation of the document, and day of the week of creation of the document.

11. A computer readable medium storing computer-executable instructions for performing the method of claim 1.

12. A computer-based document management system operable for performing the method of claim 1.

13. A method for identifying and displaying documents within a computer-based document management system, each document having a defined set of identification parameters, comprising the steps of:
providing a document viewing window for displaying all or a portion of one or more of the documents;
providing a control item comprising a plurality of selectable time-based navigation parameters;
receiving input commands setting the navigation parameters to define time-based document selection criteria;
identifying a closest-fit document having identification parameters that most closely correspond to the document selection criteria;
displaying all or a portion of the closest-fit document in the document window;
updating the navigation parameters to reflect the identification parameters of the closest-fit document; and
displaying the updated navigation parameters in connection with the control item.

14. The method of claim 13 further comprising the steps of:
identifying a group of documents corresponding to a selected one of the navigation parameters;
identifying a sub-group among the group of documents for the selected navigation parameters, the sub-group comprising documents corresponding to a current setting of the selected navigation parameter;
displaying a sub-navigation parameter in association with the selected navigation parameter identifying the number of documents in the sub-group and allowing selection among the documents in the sub-group;
receiving an input command selecting a sub-group document; and
displaying all or a portion of the selected document in the document window.

15. The method of claim 14 further comprising steps of:
displaying upon the control item the total number of documents available within the group of documents corresponding to the selected navigation parameter; and
displaying upon the control item the total number of documents available in the sub-group which corresponds to the current setting of the selected navigation parameter.

16. The method of claim 13 further comprising the steps of:
providing an additional non time-based document selection criteria, the criteria comprising documents of the same document type as the current closest-fit document;
receiving input commands enabling the document type criteria; and
limiting the available range of closest-fit documents to only those of the same document type.

17. The method of claim 16 further comprising the steps of identifying and displaying upon the control item, the total number of documents available within the document management system that satisfy the non time-based document selection criteria.

18. The method of claim 13 further comprising the steps of:
providing an additional non time-based document selection criteria, the criteria comprising documents of the same document subject as the current closest-fit document;
receiving input commands enabling the document subject criteria; and
limiting the available range of closest fit documents to only those of the same document subject.

19. A computer readable medium storing computer-executable instructions for performing the method of claim 13.

20. A computer-based document management system operable for performing the method of claim 13.
